(19) United States
(12) Patent Application Publication
(10) Pub. No.: US 2025/0201863 A1
(43) Pub. Date: Jun. 19, 2025

(54) LITHIUM METAL SECONDARY BATTERY, AND METHOD FOR PRODUCING LITHIUM METAL SECONDARY BATTERY

(71) Applicants: TOYOTA JIDOSHA KABUSHIKI KAISHA, Toyota-shi Aichi-ken (JP); TOHOKU UNIVERSITY, Aoba-ku Sendai-shi Miyagi (JP)

(72) Inventors: Daisuke Horikawa, Toyota-shi Aichi-ken (JP); Hiroyuki Yamaguchi, Toyota-shi Aichi-ken (JP); Hiroshi Tsubouchi, Nagoya-shi Aichi-ken (JP); Tetsu Ichitsubo, Sendai-shi Miyagi-ken (JP); Hongyi Li, Sendai-shi Miyagi-ken (JP)

(73) Assignees: TOYOTA JIDOSHA KABUSHIKI KAISHA, Toyota-shi Aichi-ken (JP); TOHOKU UNIVERSITY, Aoba-ku Sendai-shi Miyagi (JP)

(21) Appl. No.: 18/982,433

(22) Filed: Dec. 16, 2024

(30) Foreign Application Priority Data
Dec. 18, 2023 (JP) 2023-212997

(51) Int. Cl. H01M 4/62; H01M 4/02; H01M 4/04; H01M 4/134; H01M 4/36; H01M 4/38; H01M 10/052; H01M 10/0587

(52) U.S. Cl. CPC H01M 4/628; H01M 4/0404; H01M 4/0445; H01M 4/134; H01M 4/366; H01M 4/382; H01M 10/052; H01M 10/0587; H01M 2004/027

(57) ABSTRACT

A lithium metal secondary battery with enhanced in capacity retention rate and reduced in resistance value is provided. A lithium metal secondary battery, wherein the lithium metal secondary battery comprises a negative electrode current collector layer, a metal layer, a negative electrode active material layer, an electrolyte layer, a positive electrode active material layer, and a positive electrode current collector layer in the listed order, the negative electrode active material layer contains a lithium metal and a metal particle dispersed in the lithium metal, the metal particle contains a metal element that is taken with lithium to form an alloy, and the area ratio of the metal particle is 1×10⁻⁵% to 50% in observation of a cross section of the negative electrode active material layer in a full charge state.

### CROSS-REFERENCE TO RELATED APPLICATIONS

This application claims priority to Japanese Patent Application No. 2023-212997 filed Dec. 18, 2023, the entire contents of which are herein incorporated by reference.

### FIELD

The present disclosure relates to a lithium metal secondary battery, and a method for producing a lithium metal secondary battery.

### BACKGROUND

Lithium metal secondary batteries with lithium metals as negative electrode active materials are large in potential difference between negative electrodes and positive electrodes and thus achieve a high output voltage, and have a high theoretical capacity density and thus can be expected to be put into practical use, and the following batteries are disclosed.

For example, PTL 1 discloses a lithium secondary battery utilizing a deposition-dissolution reaction of a lithium metal, as the reaction of a negative electrode, in which the negative electrode comprises a negative electrode layer, the negative electrode layer contains an alloy of the lithium metal and a dissimilar metal, as a negative electrode active material, and the element ratio of a lithium element in the alloy in full charge of the lithium secondary battery is 40.00 atomic % or more and 99.97 atomic % or less. According to PTL 1, there can be provided a lithium secondary battery which can be enhanced in capacity retention rate.

PTL 2 discloses a secondary battery comprising a positive electrode, an electrolyte layer, a negative electrode current collector, and metal lithium as a negative electrode active material to be deposited between the electrolyte layer and the negative electrode current collector by charge, in which nitride of an element M is present between the electrolyte layer and the negative electrode current collector, the element M is an element that can be alloyed with Li, and the nitride can be covalently bound. According to the secondary battery of PTL 2, the Coulomb efficiency of the deposition and dissolution reaction of the metal lithium is described to be high.

### CITATION LIST

### Patent Literature

[PTL 1] Japanese Unexamined Patent Publication (Kokai) No. 2023-103517
[PTL 2] Japanese Unexamined Patent Publication (Kokai) No. 2023-138107

### SUMMARY

### Technical Problem

Lithium metal secondary batteries, while are expected to have desirable battery characteristics, are actually low in capacity retention rate and also high in resistance value. Therefore, lithium metal secondary batteries have room for improvement in terms of capacity retention rate and resistance value.

An object of the present disclosure is then to provide a lithium metal secondary battery enhanced in capacity retention rate and reduced in resistance value.

### Solution to Problem

The present disclosure is to achieve the above object by the following measures.

### Aspect 1

A lithium metal secondary battery, wherein
the lithium metal secondary battery comprises a negative electrode current collector layer, a metal layer, a negative electrode active material layer, an electrolyte layer, a positive electrode active material layer, and a positive electrode current collector layer in the listed order,
the negative electrode active material layer contains a lithium metal and a metal particle dispersed in the lithium metal,
the metal particle contains a metal element that is taken with lithium to form an alloy, and
the area ratio of the metal particle is 1×10⁻⁵% to 50% in observation of a cross section of the negative electrode active material layer in a full charge state.

### Aspect 2

The lithium metal secondary battery according to Aspect 1, wherein the metal layer contains a metal element constituting the metal particle.

### Aspect 3

The lithium metal secondary battery according to Aspect 1 or 2, wherein the metal element contains at least one selected from sodium, magnesium, aluminum, silicon, calcium, zinc, gallium, germanium, strontium, rhodium, palladium, barium, silver, lead, tin, iridium, gold, platinum, and bismuth.

### Aspect 4

The lithium metal secondary battery according to any one of Aspects 1 to 3, wherein the thickness of the metal layer is 5 nm to 3000 nm.

### Aspect 5

A method for producing the lithium metal secondary battery according to any one of Aspects 1 to 4, the method comprising the following steps of:
forming the metal layer on the negative electrode current collector layer and then coating a surface of the metal layer with a metal particle-containing slurry, thereby obtaining a preliminary negative electrode laminate,
stacking the preliminary negative electrode laminate, an electrolyte layer, a positive electrode active material layer that retains lithium, and a positive electrode current collector layer in the listed order, to obtain a preliminary lithium metal secondary battery, and
subjecting the preliminary lithium metal secondary battery to a charge operation, thereby depositing lithium transferred from the positive electrode active material layer, on a surface of the metal layer, to form the negative electrode active material layer and thus obtain the lithium metal secondary battery.

### Effects

According to the present disclosure, a lithium metal secondary battery is enhanced in capacity retention rate and reduced in resistance value.

### BRIEF DESCRIPTION OF DRAWINGS

FIG. 1 is a schematic view for describing the lithium metal secondary battery of the present disclosure.

FIG. 2A is a schematic view for describing the method for producing the lithium metal secondary battery of the present disclosure.

FIG. 2B is a schematic view for describing the method for producing the lithium metal secondary battery of the present disclosure.

FIG. 2C is a schematic view for describing the method for producing the lithium metal secondary battery of the present disclosure.

### DESCRIPTION OF EMBODIMENTS

Hereinafter, embodiments of the present disclosure are described in detail. Herein, the present disclosure is not limited to the following embodiments, and can be variously modified and carried out within the gist of the present disclosure. In the description of the drawings, the same symbol is applied to the same element, and the overlapped description is omitted.

In the present disclosure, the “mixture” means a composition which can directly form or further contain any other component to form a positive electrode active material layer or the like. In the present disclosure, the “mixture slurry” means a slurry which contains a dispersion medium in addition to the “mixture”, and thus can be applied and dried to form a positive electrode active material layer or the like.

The lithium metal secondary battery of the present disclosure may be a liquid-based battery containing an electrolytic solution as an electrolyte layer, or may be a solid-state battery comprising a solid electrolyte layer as an electrolyte layer. In the present disclosure, the “solid-state battery” means a battery with at least a solid electrolyte as an electrolyte, and therefore a combination of a solid electrolyte and a liquid electrolyte may be used as an electrolyte in the solid-state battery. The lithium metal secondary battery of the present disclosure may be an all-solid-state battery, namely, a battery with only a solid electrolyte as an electrolyte.

### <<Lithium Metal Secondary Battery>>

The lithium metal secondary battery of the present disclosure comprises
a negative electrode current collector layer, a metal layer, a negative electrode active material layer, an electrolyte layer, a positive electrode active material layer, and a positive electrode current collector layer in the listed order,
the negative electrode active material layer contains a lithium metal and a metal particle dispersed in the lithium metal,
the metal particle contains a metal element that is taken with lithium to form an alloy, and
the area ratio of the metal particle is 1×10⁻⁵% to 50% in observation of a cross section of the negative electrode active material layer in a full charge state.

According to the present disclosure, a lithium metal secondary battery is enhanced in capacity retention rate and reduced in resistance value.

Without being limited by theory, it is presumed that the metal layer and the metal particle dispersed in the negative electrode active material layer result in homogenization of nucleation of the lithium metal as the negative electrode active material and suppression of dendrite lithium, and thus an increase in capacity retention rate. It is also presumed that the metal layer and the metal particle dispersed in the negative electrode active material layer result in a reduction in nucleation energy of the lithium metal and thus a decrease in resistance value.

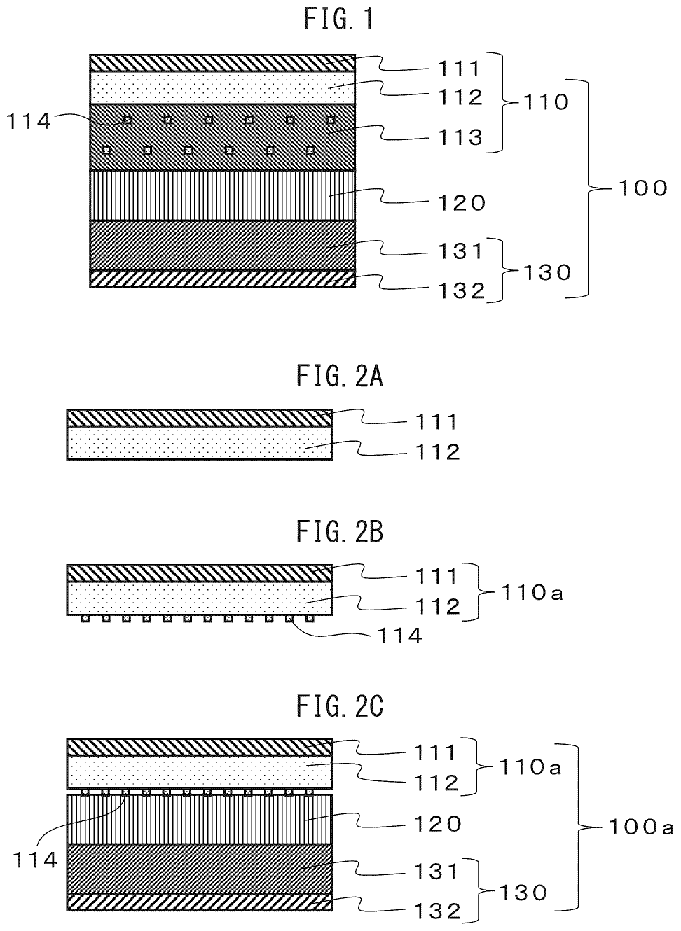

FIG. 1 is a schematic view illustrating one aspect of the lithium metal secondary battery of the present disclosure, but not limited to such a case.

A lithium metal secondary battery 100 is a battery comprising a negative electrode current collector layer 111, a metal layer 112, a negative electrode active material layer 113, an electrolyte layer 120, a positive electrode active material layer 131, and a positive electrode current collector layer 132 in the listed order. The negative electrode current collector layer 111, the metal layer 112, and the negative electrode active material layer 113 form a negative electrode laminate 110. The positive electrode active material layer 131 and the positive electrode current collector layer 132 form a positive electrode laminate 130. A metal particle 114 is dispersed in the negative electrode active material layer 113. The metal layer 112 and the metal particle 114 dispersed in the negative electrode active material layer 113 result in an increase in capacity retention rate and a decrease in resistance value. It is presumed that the metal layer 112 and the metal particle 114 dispersed in the negative electrode active material layer 113 result in homogenization of nucleation of the lithium metal as the negative electrode active material and suppression of dendrite lithium, and thus an increase in capacity retention rate. It is also presumed that the metal layer 112 and the metal particle 114 dispersed in the negative electrode active material layer 113 result in a reduction in nucleation energy of the lithium metal and thus a decrease in resistance value.

### <Configuration of Lithium Metal Secondary Battery>

The lithium metal secondary battery of the present disclosure comprises a negative electrode current collector layer, a metal layer, a negative electrode active material layer, an electrolyte layer, a positive electrode active material layer, and a positive electrode current collector layer in the listed order.

### <Negative Electrode Current Collector Layer>

The material used in the negative electrode current collector layer is not particularly limited, and a common negative electrode current collector for lithium metal secondary batteries can be appropriately selected. Examples of the material used in the negative electrode current collector layer can include Cu, Ni, Cr, Au, Pt, Ag, Al, Fe, Ti, Zn, Co, stainless steel, or a carbon sheet, but not limited to such a case. In particular, the material used in the negative electrode current collector layer may be one containing at least one selected from Cu, Ni and stainless steel or may be one made of a carbon sheet, for example, from the viewpoint of ensuring the reduction resistance and from the viewpoint of hardly alloying with lithium. The negative electrode current collector layer may have any coat layer on the surface thereof for the purpose of, for example, adjustment of the resistance.

The shape of the negative electrode current collector layer is not particularly limited, and examples can include a foil shape, a plate shape, or a mesh shape. In some embodiments, a foil shape is selected.

The thickness of the negative electrode current collector layer is not particularly limited, and may be 0.1 μm or more, or 1 μm or more, and may be 1 mm or less, or 100 μm or less.

### <Metal Layer>

The metal layer is a layer containing a metal element, and may contain a metal element constituting a metal particle described below.

The metal layer is not particularly limited, and may contain at least one selected from sodium, magnesium, aluminum, silicon, calcium, zinc, gallium, germanium, strontium, rhodium, palladium, barium, silver, lead, tin, iridium, gold, platinum, and bismuth.

The thickness of the metal layer is not particularly limited, and may be 5 nm to 3000 nm. The thickness of the metal layer can be measured by observation of a cross section of the metal layer with a scanning electron microscope (SEM).

The metal layer can be formed with reference to the description of “<<Method for producing lithium metal secondary battery>>” below.

### <Negative Electrode Active Material Layer>

In the lithium metal secondary battery of the present disclosure, the negative electrode active material layer contains a lithium metal and a metal particle dispersed in the lithium metal.

In the “negative electrode active material layer”, a layer of the lithium metal as the “negative electrode active material layer” is present in a charge state, whereas the lithium metal is moved as a lithium ion to the positive electrode active material layer and no layer of the lithium metal as the “negative electrode active material layer” may be present in a discharge state.

The dispersion state of the metal particle dispersed in the negative electrode active material layer is not particularly limited. The metal particle may be, for example, monodispersed, or dispersed as an aggregate of the metal particle. The position of the metal particle may also be changed depending on the change in thickness of the negative electrode active material layer along with charge and discharge.

The negative electrode active material layer contains at least the lithium metal and the metal particle in the negative electrode active material, and may further optionally contain a conductive aid, a binder, a solid electrolyte, and the like. The negative electrode active material layer may contain various other additives. The content of each of the negative electrode active material, the conductive aid, the binder, the solid electrolyte, and the like in the negative electrode active material layer may be appropriately determined depending on the objective battery performance. For example, when the total (total solid content) of the negative electrode active material layer is assumed to be 100% by mass, the content of the lithium metal as the negative electrode active material may be 40% by mass or more, 50% by mass or more, 60% by mass or more, and may be 99% by mass or less, or 90% by mass or less.

### (Negative Electrode Active Material)

The negative electrode active material here used is at least the lithium metal as described above. Any other negative electrode active material than the lithium metal may be contained in the negative electrode active material layer. Such any other negative electrode active material than the lithium metal is not particularly limited, and examples include a carbon material. Examples of the carbon material include hard carbon, soft carbon, and graphite, but not limited to these cases.

### (Metal Particle)

The metal particle contains a metal element to be alloyed with lithium.

The metal element is not particularly limited, and may contain at least one selected from sodium, magnesium, aluminum, silicon, calcium, zinc, gallium, germanium, strontium, rhodium, palladium, barium, silver, lead, tin, iridium, gold, platinum, and bismuth.

The area ratio of the metal particle contained in the negative electrode active material layer is 1×10⁻⁵% to 50% in observation of a cross section of the negative electrode active material layer in a full charge state.

The area ratio of the metal particle can be determined by disassembling the lithium metal secondary battery in a full charge state, and subjecting a cross section of the negative electrode active material layer to observation with a scanning electron microscope (SEM) and element mapping by energy dispersive X-ray analysis (EDX). Specifically, the area of the cross section observed of the negative electrode active material layer is measured from an SEM image and thus calculated. Next, the area of the metal particle present in the cross section observed of the negative electrode active material layer is measured from the SEM image and thus calculated. The area ratio can be then determined by calculating the proportion of the area of the metal particle to the area of the negative electrode active material layer.

The particle size of the metal particle is not particularly limited, and, for example, may be 1 nm or more, 5 nm or more, or 10 nm or more, and may be 200 nm or less, 100 nm or less, 50 nm or less, 20 nm or less, or 10 nm or less. The particle size of the metal particle can be measured by observation of a cross section of the metal layer with a scanning electron microscope (SEM).

(Binder) The binder is not particularly limited. The binder may be, for example, a material such as polyvinylidene fluoride (PVdF), butadiene rubber (BR), polytetrafluoroethylene (PTFE), or styrene-butadiene rubber (SBR), but not limited thereto. The binder is not particularly limited, and may be used singly or in combination of two or more kinds thereof.

### (Conductive Aid)

The conductive aid is not particularly limited. The conductive aid may be, for example, a vapor-grown carbon fiber (VGCF), acetylene black (AB), Ketjen black (KB), a carbon nanotube (CNT), or a carbon nanofiber (CNF), but not limited thereto. The conductive aid may be, for example, particulate or fibrous, and the size thereof is not particularly limited. The conductive aid is not particularly limited, and may be used singly or in combination of two or more kinds thereof.

### (Solid Electrolyte)

The material of the solid electrolyte is not particularly limited, and may be, for example, a sulfide solid electrolyte, an oxide solid electrolyte, or a polymer electrolyte.

Examples of the sulfide solid electrolyte include a sulfide-based amorphous solid electrolyte, a sulfide-based crystalline solid electrolyte, or an argyrodite-type solid electrolyte, but not limited thereto. Specific examples of the sulfide solid electrolyte can include Li₂S—P₂S₅-based solid electrolyte (Li₇P₃S₁₁, Li₃PS₄, Li₈P₂S₉, or the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, or the like), LiI—Li₂S—P₂O₅, LiI—Li₃PO₄—P₂S₅, or Li₇₋ₓPS₆₋ₓClₓ; or any combination thereof, but not limited thereto.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON), but not limited thereto.

The sulfide solid electrolyte and the oxide solid electrolyte may be each glass or crystallized glass (glass ceramics).

Examples of the polymer electrolyte include polyethylene oxide (PEO), polypropylene oxide (PPO), and any copolymer thereof, but not limited thereto.

The shape of the negative electrode active material is not particularly limited, and may be a shape common to negative electrode active materials for lithium metal secondary batteries. The negative electrode active material may have, for example, a layer shape or a sheet shape. The negative electrode active material may undergo deposition of lithium during charge, and/or may undergo dissolution of lithium during discharge. In this case, the negative electrode active material layer may be a layer composed of the lithium metal.

The shape of the negative electrode active material layer is not particularly limited, and may be, for example, a sheet-shaped negative electrode active material layer having a substantially flat surface. The thickness of the negative electrode active material layer is not particularly limited, and, for example, may be 0.1 m or more, 1 m or more, or 10 m or more, and may be 200 m or less, 1150 m or less, or 100 m or less.

The negative electrode active material layer can be formed with reference to the description of “<<Method for producing lithium metal secondary battery>>” below.

### <Electrolyte Layer>

### <Electrolyte Layer-Solid Electrolyte Layer>

The lithium metal secondary battery of the present disclosure can have a solid-state battery, namely, can have a solid electrolyte layer as the electrolyte layer.

The solid electrolyte layer may contain, if necessary, for example, a binder, in addition to the solid electrolyte.

The thickness of the solid electrolyte layer is not particularly limited, and, for example, may be 0.1 m or more, 1 m or more, or 10 m or more, and may be 2 mm or less, 1 mm or less, or 500 m or less.

The solid electrolyte layer can be easily formed by, for example, dry or wet molding of an electrolyte mixture containing, for example, the above solid electrolyte and binder.

### <Electrolyte Layer-Separator Layer>

The lithium metal secondary battery of the present disclosure can be a liquid-based battery, namely, can have an electrolytic solution as the electrolyte layer, in particular, an electrolytic solution retained in a separator layer.

### (Electrolytic Solution)

The electrolytic solution is not particularly limited, and, in some embodiments, contains a supporting salt and a solvent.

The supporting salt (lithium salt) of an electrolytic solution having lithium ion conductivity is not particularly limited, and examples include an inorganic lithium salt and an organic lithium salt. Examples of the inorganic lithium salt include LiPF₆, LiBF₄, LiClO₄, or LiAsF₆, but not limited to these cases. Examples of the organic lithium salt include LiCF₃SO₃, LiN(CF₃SO₂)₂, LiN(C₂F₅SO₂)₂, LiN(FSO₂)₂, or LiC(CF₃SO₂)₃, but not limited to these cases.

The solvent used in the electrolytic solution is not particularly limited, and examples can include cyclic carbonate or linear carbonate. Examples of the cyclic carbonate can include ethylene carbonate (EC), propylene carbonate (PC), or butylene carbonate (BC), but not limited to such a case. Examples of the linear carbonate include dimethyl carbonate (DMC), diethyl carbonate (DEC), or ethyl methyl carbonate (EMC), but not limited to such a case. The electrolytic solution is not particularly limited, and may be used singly or in combination of two or more kinds thereof.

### (Separator)

The separator is not particularly limited, and a common separator for lithium metal secondary batteries can be appropriately selected. The separator here used can be, for example, a polyolefin-based, polyamide-based, or polyimide-based non-woven fabric.

### <Positive Electrode Active Material Layer>

The positive electrode active material layer contains at least a positive electrode active material, and may further optionally contain a conductive aid, a solid electrolyte, a binder, and the like. The positive electrode active material layer may contain various other additives. The content of each of the positive electrode active material, the conductive aid, the binder, and the like in the positive electrode active material layer may be appropriately determined depending on the objective battery performance. For example, when the total (total solid content) of the positive electrode active material layer is assumed to be 100% by mass, the content of the positive electrode active material may be 40% by mass or more, 50% by mass or more, 60% by mass or more, and may be 100% by mass or less, or 90% by mass or less.

### (Positive Electrode Active Material)

The material of the positive electrode active material is not particularly limited as long as it can occlude and release a lithium ion. The positive electrode active material may be, for example, lithium cobaltate (LiCoO₂), lithium nickelate (LiNiO₂), lithium manganate (LiMn₂O₄), lithium nickelate/cobaltate/manganate (NCM), LiCO_{1/3}Ni_{1/3}Mn_{1/3}O₂, lithium nickelate/cobaltate/aluminate (NCA; LiNiₓCo_{y}Al_{z}O₂), or Li—Mn spinel having a composition represented by Li₁₊ₓMn_{2-x-y}M_{y}O₄ (M is one or more metal elements selected from Al, Mg, Co, Fe, Ni, and Zn) by substitution with a dissimilar element, but not limited thereto.

The positive electrode active material is not particularly limited, and may have a covering layer. The covering layer is a layer containing a substance which has lithium ion conductive performance, which is low in reactivity with the positive electrode active material and the solid electrolyte, and which does not flow even if contacted with the active material or the solid electrolyte and then can allow the form of the covering layer to be kept. Specific examples of the material constituting the covering layer can include Li₄Ti₅O₁₂ or Li₃PO₄, in addition to LiNbO₃, but not limited thereto.

The shape of the positive electrode active material is not particularly limited as long as it is a shape common to positive electrode active materials for lithium metal secondary batteries. The positive electrode active material may be, for example, particulate. The positive electrode active material may be a primary particle, or may be a secondary particle of a plurality of primary particles aggregated. The average particle size D₅₀ of the positive electrode active material, for example, may be 1 nm or more, 5 nm or more, or 10 nm or more, and may be 500 μm or less, 100 μm or less, 50 μm or less, or 30 μm or less. The average particle size D₅₀ is here a particle size (median size) at which the cumulative value in a particle size distribution on a volume basis, determined by a laser diffraction/scattering method, is 50%.

The solid electrolyte, the binder, and the conductive aid can be determined with reference to the description of “<Negative electrode active material layer>”.

The shape of the positive electrode active material layer is not particularly limited, and may be, for example, a sheet-shaped positive electrode active material layer having a substantially flat surface. The thickness of the positive electrode active material layer is not particularly limited, and, for example, may be 0.1 μm or more, 1 μm or more, or 10 μm or more, and may be 2 mm or less, 1 mm or less, or 500 μm or less.

### <Positive Electrode Current Collector Layer>

The material used in the positive electrode current collector layer is not particularly limited, and a common positive electrode current collector for lithium metal secondary batteries can be appropriately adopted. Examples of the material used in the positive electrode current collector layer can include Cu, Ni, Cr, Au, Pt, Ag, Al, Fe, Ti, Zn, Co, or stainless steel, but not limited to such a case. The positive electrode current collector layer may have any coat layer on the surface thereof for the purpose of, for example, adjustment of the resistance. The positive electrode current collector layer may be a metal foil or substrate on which the above metal is plated or vapor-deposited.

The shape of the positive electrode current collector layer is not particularly limited, and examples can include a foil shape, a plate shape, or a mesh shape. In some embodiments, a foil shape is selected.

The thickness of the positive electrode current collector layer is not particularly limited, and may be 0.1 μm or more, or 1 μm or more, and may be 1 mm or less, or 100 μm or less.

The positive electrode active material layer can be produced by applying a known method. For example, the positive electrode active material layer can be easily formed by dry or wet molding of a positive electrode mixture containing various components described above. The positive electrode active material layer may be formed together with the positive electrode current collector layer, or may be formed separately from the positive electrode current collector layer.

### <Shape of Lithium Metal Secondary Battery>

Examples of the shape of the lithium metal secondary battery include a coin shape, a laminate shape (pouch battery), a cylindrical shape, or a square shape, but not limited to these cases.

### <<Method for Producing Lithium Metal Secondary Battery>>

The lithium metal secondary battery of the present disclosure can be produced by a production method comprising the following steps of:
forming the metal layer on the negative electrode current collector layer and then coating a surface of the metal layer with a metal particle-containing slurry, thereby obtaining a preliminary negative electrode laminate,
stacking the preliminary negative electrode laminate, an electrolyte layer, a positive electrode active material layer that retains lithium, and a positive electrode current collector layer in the listed order, to obtain a preliminary lithium metal secondary battery, and
subjecting the preliminary lithium metal secondary battery to a charge operation, thereby depositing lithium transferred from the positive electrode active material layer, on a surface of the metal layer, to form the negative electrode active material layer and thus obtain the lithium metal secondary battery.

According to the method for producing the lithium metal secondary battery of the present disclosure, it is possible to produce a lithium metal secondary battery enhanced in capacity retention rate and reduced in resistance value.

FIGS. 2A, 2B, and 2C are schematic views illustrating one aspect of the method for producing the lithium metal secondary battery of the present disclosure, but not limited to such a case. The method for producing the lithium metal secondary battery of the present disclosure is described with FIG. 1 and FIGS. 2A, 2B, and 2C.

First, a metal element is film-formed on a surface of a negative electrode current collector layer 111 by a vapor-deposition system, thereby forming a metal layer 112 (FIG. 2A). Next, a surface of the metal layer 112 is coated with a metal particle-containing slurry, thereby forming a metal layer 112 coated with a metal particle 114, to form a preliminary negative electrode laminate 110a (FIG. 2B). Next, a positive electrode mixture is applied onto a positive electrode current collector layer 132 in a wet or dry manner, thereby forming a positive electrode active material layer 131, to form a positive electrode laminate 130, and the preliminary negative electrode laminate 110a, an electrolyte layer 120, and the positive electrode laminate 130 are stacked, thereby forming a preliminary lithium metal secondary battery 100a comprising the negative electrode current collector layer 111, the metal layer 112 coated with the metal particle 114, the electrolyte layer 120, the positive electrode active material layer 131, and the positive electrode current collector layer 132 in the listed order (FIG. 2C). The preliminary lithium metal secondary battery 100a can be subjected to a charge operation, thereby depositing lithium transferred from the positive electrode active material layer, on a surface of the metal layer 112, to form a negative electrode active material layer 113 and thus form a lithium metal secondary battery 100 (FIG. 1). While lithium is deposited on the surface of the metal layer 112 by the charge operation, the metal particle 114 with which the surface of the metal layer 112 is coated is diffused and dispersed in a lithium metal layer as the negative electrode active material layer 113 (FIG. 1).

### <Formation of Preliminary Negative Electrode Laminate>

The preliminary negative electrode laminate can be formed by forming a metal layer on a negative electrode current collector layer, and then coating a surface of the metal layer with a metal particle-containing slurry.

### (Preliminary Negative Electrode Laminate)

The preliminary negative electrode laminate is not particularly limited, and is a laminate where the negative electrode current collector and the metal layer coated with the metal particle are stacked in the listed order.

### (Formation of Metal Layer)

The metal layer is not particularly limited, and can be formed by film-forming the metal element on a surface of the negative electrode current collector layer by a vapor-deposition system.

(Coating with Metal Particle-Containing Slurry)

The metal particle-containing slurry is not particularly limited, and can be prepared by mixing a powder of the metal element, the binder, and a moderate amount of a dispersion medium. The coating method of the metal particle-containing slurry is not particularly limited, and a surface of the metal layer can be coated with the slurry by a known coating method. The binder here used can be, for example, polyvinylidene fluoride (PVdF), butadiene rubber (BR), polytetrafluoroethylene (PTFE), or styrene-butadiene rubber (SBR). The dispersion medium here used can be, for example, N-methyl-2-pyrrolidone (NMP).

### <Formation of Preliminary Lithium Metal Secondary Battery>

The preliminary lithium metal secondary battery can be formed by stacking the preliminary negative electrode laminate, the electrolyte layer, a positive electrode active material layer that retains lithium, and the positive electrode current collector layer in the listed order.

### (Preliminary Lithium Metal Secondary Battery)

The preliminary lithium metal secondary battery is not particularly limited, and is a laminate where the preliminary negative electrode laminate, the electrolyte layer, the positive electrode active material layer, and the positive electrode current collector layer are stacked in the listed order, namely, a laminate where the negative electrode current collector, and the metal layer coated with the metal particle, the electrolyte layer, the positive electrode active material layer, and the positive electrode current collector layer are stacked in the listed order.

### <Formation of Lithium Metal Secondary Battery>

The lithium metal secondary battery can be formed by subjecting the preliminary lithium metal secondary battery to a charge operation, thereby depositing lithium transferred from the positive electrode active material layer, on a surface of the metal layer, to form the negative electrode active material layer.

### (Charge Operation)

The charge operation can be performed, for example, in a cut-off voltage range of 3.3 to 4.2 V under a constant current condition. The amount of current (C rate) in the charge operation is not particularly limited, and may be 0.01 C or more, 0.1 C or more, 0.5 C or more, or 1.0 C or more, and may be 2.0 C or less, 1.5 C or less, 1.2 C or less, or 1.0 C or less.

### (Formation of Negative Electrode Active Material Layer)

The negative electrode active material layer is not particularly limited, and the negative electrode active material layer can be formed by subjecting the preliminary lithium metal secondary battery to the charge operation, to release lithium from a positive electrode active material that retains lithium, and deposit the lithium on the metal layer. Here, a surface of the metal layer is coated with the metal particle, and the metal particle is diffused in a lithium metal layer along with deposition of lithium, thereby allowing for formation of a negative electrode active material layer where the metal particle is dispersed.

### EXAMPLES

The present disclosure is described in further detail with reference to Examples shown below, but the scope of the present disclosure is not limited to these Examples.

### Example 1

### <Production of Preliminary Negative Electrode Laminate>

Tin (Sn) was film-formed on one surface of copper (Cu) foil as a negative electrode current collector by a vapor deposition method, to form a metal layer on the Cu foil. The thickness of the metal layer was 600 nm. Next, a Sn powder as a metal particle, which was the same metal element as in the metal layer, polyvinylidene fluoride (PVdF), and a moderate amount of N-methyl-2-pyrrolidone (NMP) were mixed, to prepare a slurry containing the metal element. Thereafter, the slurry containing the metal element was applied onto the metal layer, and dried in vacuum at 80° C., to produce a preliminary negative electrode laminate.

### <Production of Positive Electrode Laminate>

A positive electrode mixture slurry was prepared by mixing LiNi_{1/3}Co_{1/3}Mn_{1/3}O₂ (84 parts by mass) as a positive electrode active material, acetylene black (12 parts by mass) as a conductive aid, PVdF (4 parts by mass) as a binder, and a moderate amount of NMP as a dispersion medium. Next, the resulting positive electrode mixture slurry was applied onto aluminum (Al) foil as a positive electrode current collector, and dried, thereby producing a positive electrode laminate in which a positive electrode active material layer was formed on a positive electrode current collector layer.

### <Production of Preliminary Lithium Metal Secondary Battery>

The preliminary negative electrode laminate and the positive electrode laminate were stacked so as to be opposite with a polyolefin film (film thickness 20 μm) as a separator being interposed therebetween, and wound in a spiral manner. Respective terminals were connected to the preliminary negative electrode laminate and the positive electrode laminate wound, and were received in a battery case, 1 M LiPF₆ ethylene carbonate/dimethyl carbonate (1/1, volume ratio) as an electrolytic solution was injected thereinto, and the battery case was sealed, to produce a preliminary lithium metal secondary battery.

### <Formation of Lithium Metal Secondary Battery and Evaluation of Capacity Retention Rate Thereof>

The preliminary lithium metal secondary battery was charged and discharged for 200 cycles with a constant-current (current rate 1 C) system in a cut-off voltage range of 3.3 to 4.2 V at 25° C. The capacity was measured at the first cycle and the 200-th cycle, and the capacity retention rate (Capacity retention rate=(Capacity at 200-th cycle)/(Capacity at first cycle)×100) was calculated. Table 1 shows the results of the capacity retention rate. The capacity retention rate in Table 1 is a relative value in a case where the capacity retention rate of the lithium metal secondary battery in Comparative Example 1 is 1.00. The preliminary lithium metal secondary battery was here subjected to a charge operation, thereby depositing lithium transferred from the positive electrode active material layer, on the metal layer, to form a lithium metal layer as a negative electrode active material layer and thus form a lithium metal secondary battery.

### <Evaluation of Resistance Value of Lithium Metal Secondary Battery>

The lithium metal secondary battery was adjusted so that the open voltage was 3.70 V. Next, the voltage drop (ΔV) was acquired in discharge at −10° C. and a current rate of 5 C for 8 seconds, and the resistance value (current value at a resistance value of ΔV/5 C) was calculated. Table 1 shows the results of the resistance value. The resistance value in Table 1 is a relative value in a case where the resistance value of the battery in Comparative Example 1 is 1.00.

### <Area Ratio of Metal Particle in Negative Electrode Active Material Layer>

The lithium metal secondary battery in a full charge state was disassembled, and the negative electrode active material layer was recovered. Next, a cross section of the negative electrode active material layer was subjected to observation with a scanning electron microscope (SEM) and element mapping by energy dispersive X-ray analysis (EDX), and the area ratio of the metal particle relative to the negative electrode active material layer was calculated. The area ratio of the metal particle relative to the negative electrode active material layer was 1%.

### Comparative Example 1

Cu foil as a negative electrode current collector having no metal layer was adopted as a preliminary negative electrode laminate.

### <Production of Lithium Metal Secondary Battery, Evaluation of Capacity Retention Rate Thereof, and Evaluation of Resistance Value Thereof>

A lithium metal secondary battery was produced with the preliminary negative electrode laminate of only Cu foil in Comparative Example 1, by the same method as in Example 1. No metal particle was contained, and thus the area ratio of the metal particle relative to the negative electrode active material layer was 0%. The capacity retention rate and the resistance value of the lithium metal secondary battery were evaluated by the same methods as in Example 1. In Examples and Comparative Examples herein, each relative value is shown in a case where the capacity retention rate and the resistance value of the lithium metal secondary battery in Comparative Example 1 are each 1.00.

### Examples 2 to 8 and Comparative Examples 2 and 3 (Influence of Area Ratio of Metal Particle)

### <Production of Preliminary Negative Electrode Laminate>

Each preliminary negative electrode laminate was produced by the same method as in Example 1 except that each amount of application of the paste containing Sn as the metal particle was adjusted.

### <Production of Lithium Metal Secondary Battery, Evaluation of Capacity Retention Rate Thereof, and Evaluation of Resistance Value Thereof>

A lithium metal secondary battery was produced with the preliminary negative electrode laminate produced in each of Examples 2 to 8 and Comparative Examples 2 and 3, by the same method as in Example 1. The area ratio of the metal particle relative to the negative electrode active material layer was as shown in Table 2. The capacity retention rate and the resistance value of the lithium metal secondary battery in each of Examples 2 to 8 and Comparative Examples 2 and 3 were evaluated by the same methods as in Example 1. The respective results were as shown in Table 1.

TABLE 1

| | Negative electrode laminate | | | Evaluation results | |
|---|---|---|---|---|---|
| | | | Area ratio of metal particle | Capacity retention rate | |
| | Material of metal | Thickness of | relative to negative electrode | relative to Comparative | Resistance value relative |
| | layer and metal | metal layer | active material layer | Example 1 | to Comparative Example 1 |
| | particle | [nm] | [%] | [—] | [—] |
| Comparative | — | — | — | 1.00 | 1.00 |
| Example 1 | | | | | |
| Example 1 | Tin (Sn) | 600 | 1 | 1.43 | 0.48 |
| Example 2 | Tin (Sn) | 600 | 2 | 1.57 | 0.59 |
| Example 3 | Tin (Sn) | 600 | 10 | 1.57 | 0.55 |
| Example 4 | Tin (Sn) | 600 | 25 | 1.52 | 0.55 |
| Example 5 | Tin (Sn) | 600 | 50 | 1.50 | 0.59 |
| Comparative | Tin (Sn) | 600 | 60 | 1.29 | 0.75 |
| Example 2 | | | | | |
| Example 6 | Tin (Sn) | 600 | 1 × 10⁻¹ | 1.48 | 0.58 |
| Example 7 | Tin (Sn) | 600 | 1 × 10⁻³ | 1.49 | 0.53 |
| Example 8 | Tin (Sn) | 600 | 1 × 10⁻⁵ | 1.51 | 0.55 |
| Comparative | Tin (Sn) | 600 | 1 × 10⁻⁶ | 1.33 | 0.79 |
| Example 3 | | | | | |

The lithium metal secondary battery comprising the metal layer, in which the negative electrode active material layer contained a lithium metal and a metal particle dispersed in the lithium metal, was increased in capacity retention rate and decreased in resistance value as compared with the lithium metal secondary battery in Comparative Example 1. In particular, the lithium metal secondary battery comprising the negative electrode active material layer where the area ratio of the metal particle relative to the negative electrode active material layer was 1×10⁻⁵ to 50% was significantly improved in capacity retention rate and resistance value as compared with the lithium metal secondary battery in Comparative Example 1.

It was presumed that, in a case where the metal layer was contained and a predetermined amount of the metal particle was dispersed in the negative electrode active material layer, lithium metal nucleation was homogenized and dendrite lithium was suppressed, resulting in an increase in capacity retention rate. It was also presumed that a predetermined amount of the metal particle resulted in a reduction in nucleation energy and thus a decrease in resistance value.

### Examples 9 to 13 (Influence of Thickness of Metal Layer)

### <Production of Preliminary Negative Electrode Laminate>

Each preliminary negative electrode laminate was produced by the same method as in Example 1 except that the thickness of the metal layer was as described in Table 2, by adjustment of the film-forming time of Sn with a vapor deposition method.

### <Production of Lithium Metal Secondary Battery, Evaluation of Capacity Retention Rate Thereof, and Evaluation of Resistance Value Thereof>

A lithium metal secondary battery was produced with the preliminary negative electrode laminate produced in each of Examples 9 to 13, by the same method as in Example 1. The same amount of application of the paste containing Sn as the metal particle was adopted in such production of the preliminary negative electrode laminate, and thus the area ratio of the metal particle relative to the negative electrode active material layer in each of Example 9 to 13 was 1% as in Example 1. The capacity retention rate and the resistance value of the lithium metal secondary battery in each of Examples 9 to 13 were evaluated by the same methods as in Example 1. The respective results were as shown in Table 2.

TABLE 2

| | Negative electrode laminate | | | Evaluation results | |
|---|---|---|---|---|---|
| | | | Area ratio of metal | Capacity retention | Resistance value |
| | | | particle relative to | rate relative to | relative to |
| | | Thickness of | negative electrode active | Comparative | Comparative |
| | Material of metal layer | metal layer | material layer | Example 1 | Example 1 |
| | and metal particle | [nm] | [%] | [—] | [—] |
| Comparative | — | — | — | 1.00 | 1.00 |
| Example 1 | | | | | |
| Example 9 | Tin (Sn) | 5 | 1 | 1.46 | 0.51 |
| Example 10 | Tin (Sn) | 50 | 1 | 1.45 | 0.53 |
| Example 11 | Tin (Sn) | 200 | 1 | 1.55 | 0.49 |
| Example 1 | Tin (Sn) | 600 | 1 | 1.43 | 0.48 |
| Example 12 | Tin (Sn) | 1000 | 1 | 1.59 | 0.55 |
| Example 13 | Tin (Sn) | 3000 | 1 | 1.40 | 0.53 |

The lithium metal secondary battery where the area ratio of the metal particle in the negative electrode active material layer was 1% and the thickness of the metal layer was 5 nm to 3000 nm was evaluated in each of Example 1 and Examples 9 to 13. The lithium metal secondary battery, in which the thickness of the metal layer was within a wide range of 5 nm to 3000 nm, was increased in capacity retention rate and reduced in resistance value, as compared with the lithium metal secondary battery in Comparative Example 1.

### Examples 14 to 31 (Influence of Material of Metal Layer and Metal Particle)

Each preliminary negative electrode laminate was produced by the same method as in Example 1 except that the metal layer and the material of the metal particle were as described in Table 3.

### <Production of Lithium Metal Secondary Battery, Evaluation of Capacity Retention Rate Thereof, and Evaluation of Resistance Value Thereof>

A lithium metal secondary battery was produced with the preliminary negative electrode laminate produced in each of Examples 14 to 31, by the same method as in Example 1. The same amount of application of the paste containing Sn as the metal particle was adopted in such production of the preliminary negative electrode laminate, and thus the area ratio of the metal particle relative to the negative electrode active material layer in each of Examples 14 to 31 was 1% as in Example 1. The capacity retention rate and the resistance value of the lithium metal secondary battery in each of Examples 14 to 31 were evaluated by the same methods as in Example 1. The respective results were as shown in Table 3.

TABLE 3

| | Negative electrode laminate | | | Evaluation results | |
|---|---|---|---|---|---|
| | | | Area ratio of metal particle | Capacity retention rate | Resistance value relative |
| | | Thickness of | relative to negative electrode | relative to Comparative | to Comparative |
| | Material of metal layer | metal layer | active material layer | Example 1 | Example 1 |
| | and metal particle | [nm] | [%] | [—] | [—] |
| Comparative | — | — | — | 1.00 | 1.00 |
| Example 1 | | | | | |
| Example 4 | Tin (Sn) | 600 | 1 | 1.43 | 0.48 |
| Example 14 | Sodium (Na) | 600 | 1 | 1.43 | 0.48 |
| Example 15 | Magnesium (Mg) | 600 | 1 | 1.47 | 0.52 |
| Example 16 | Aluminum (Al) | 600 | 1 | 1.41 | 0.54 |
| Example 17 | Silicon (Si) | 600 | 1 | 1.53 | 0.52 |
| Example 18 | Bismuth (Bi) | 600 | 1 | 1.42 | 0.58 |
| Example 19 | Zinc (Zn) | 600 | 1 | 1.43 | 0.59 |
| Example 20 | Gallium (Ga) | 600 | 1 | 1.44 | 0.54 |
| Example 21 | Germanium (Ge) | 600 | 1 | 1.42 | 0.55 |
| Example 22 | Calcium (Ca) | 600 | 1 | 1.51 | 0.56 |
| Example 23 | Strontium (Sr) | 600 | 1 | 1.41 | 0.52 |
| Example 24 | Rhodium (Rh) | 600 | 1 | 1.42 | 0.58 |
| Example 25 | Palladium (Pd) | 600 | 1 | 1.53 | 0.54 |
| Example 26 | Barium (Ba) | 600 | 1 | 1.41 | 0.52 |
| Example 27 | Silver (Ag) | 600 | 1 | 1.55 | 0.56 |
| Example 28 | Lead (Pb) | 600 | 1 | 1.42 | 0.54 |
| Example 29 | Iridium (Ir) | 600 | 1 | 1.53 | 0.55 |
| Example 30 | Gold (Au) | 600 | 1 | 1.47 | 0.54 |
| Example 31 | Platinum (Pt) | 600 | 1 | 1.48 | 0.55 |

Even in a case where the material of the metal layer and the metal particle was other than Sn (Examples 14 to 31), the capacity retention rate was increased and the resistance value was reduced. Even in a case where the material of the metal layer and the metal particle contained various metal elements that could be taken with lithium to form an alloy, it was presumed that the metal layer and the metal particle dispersed in the negative electrode resulted in homogenization of lithium metal nucleation and suppression of dendrite lithium, and thus an enhancement in capacity retention rate. It was also presumed that the metal layer and the metal particle resulted in a reduction in nucleation energy and thus a reduction in battery resistance.

Although embodiments of the lithium metal secondary battery and the method for producing the lithium metal secondary battery of the present disclosure are described, it is understood by those skilled in the art that modifications can be made without departing from the claims.

### REFERENCE SIGNS LIST

100 Lithium metal secondary battery
100a Preliminary lithium metal secondary battery
110 Negative electrode laminate
110a Preliminary negative electrode laminate
111 Negative electrode current collector layer
112 Metal layer
113 Negative electrode active material layer
114 Metal particle
120 Electrolyte layer
130 Positive electrode laminate
131 Positive Electrode active material layer
132 Positive electrode current collector layer

1. A lithium metal secondary battery, wherein
the lithium metal secondary battery comprises a negative electrode current collector layer, a metal layer, a negative electrode active material layer, an electrolyte layer, a positive electrode active material layer, and a positive electrode current collector layer in the listed order,
the negative electrode active material layer contains a lithium metal and a metal particle dispersed in the lithium metal,
the metal particle contains a metal element that is taken with lithium to form an alloy, and
the area ratio of the metal particle is 1×10⁻⁵% to 50% in observation of a cross section of the negative electrode active material layer in a full charge state.

2. The lithium metal secondary battery according to claim 1, wherein the metal layer contains a metal element constituting the metal particle.

3. The lithium metal secondary battery according to claim 1, wherein the metal element contains at least one selected from sodium, magnesium, aluminum, silicon, calcium, zinc, gallium, germanium, strontium, rhodium, palladium, barium, silver, lead, tin, iridium, gold, platinum, and bismuth.

4. The lithium metal secondary battery according to claim 1, wherein the thickness of the metal layer is 5 nm to 3000 nm.

5. A method for producing the lithium metal secondary battery according to claim 1, the method comprising the following steps of:
forming the metal layer on the negative electrode current collector layer and then coating a surface of the metal layer with a metal particle-containing slurry, thereby obtaining a preliminary negative electrode laminate,
stacking the preliminary negative electrode laminate, an electrolyte layer, a positive electrode active material layer that retains lithium, and a positive electrode current collector layer in the listed order, to obtain a preliminary lithium metal secondary battery, and
subjecting the preliminary lithium metal secondary battery to a charge operation, thereby depositing lithium transferred from the positive electrode active material layer, on a surface of the metal layer, to form the negative electrode active material layer and thus obtain the lithium metal secondary battery.
